(19) United States
(12) Patent Application Publication
(10) Pub. No.: US 2007/0092291 A1
(43) Pub. Date: Apr. 26, 2007

(54) CARTRIDGE AND A PROCESS FOR MANUFACTURING A CARTRIDGE

(75) Inventors: Akira SUZUKI, Kanagawa-ken (JP); Osamu Anan, Susono-shi (JP); Jun Miyamoto, Mishima-shi (JP); Koji Hashimoto, Shizuoka-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/538,616

(22) Filed: Oct. 4, 2006

(30) Foreign Application Priority Data
Oct. 7, 2005 (JP) 2005-294620

(51) Int. Cl. G03G 21/18

(52) U.S. Cl. 399/111

(57) ABSTRACT

To provide a cartridge and a toner container each of which does not increase a material cost and is excellent in impact resistance against, for example, a vibration or a fall, the impact resistance being a needed function. The cartridge and the toner container each include a first part molded out of a laser light absorptive styrene resin composition and a second part molded out of a laser light transmissive styrene resin composition, the first part and the second part being joined with each other by laser welding. In each of the cartridge and the toner container, the transmittance of each of the parts is adjusted depending on, for example, the particle size and amount of rubber in each of the styrene resin compositions, or the kind of a flame retardant in each of the compositions.

### BACKGROUND OF THE INVENTION

1. Field of the Invention

The present invention relates to a cartridge, which is detachable from an electrophotographic image forming device employing an electrophotographic process such as a laser printer or a copying machine, and a process for manufacturing a cartridge.

The term “electrophotographic image forming device” as used herein refers to a device that employs an electrophotographic image forming process to form an image on a recording medium. Examples of the electrophotographic image forming device include an electrophotographic copying machine, an electrophotographic printer (such as a laser beam printer or an LED printer), a facsimile device, and a word processor. A process cartridge is a member into which charging means, developing means, or cleaning means and an electrophotographic photosensitive member are integrated as a cartridge, the member being detachable from a main body of an image forming device.

2. Description of the Related Art

A mode (i.e., process cartridge mode) has been conventionally adopted, in which a process cartridge obtained by integrating an electrophotographic photosensitive drum (hereinafter referred to as “photosensitive drum”) and process means acting on the photosensitive drum into a cartridge is made detachable from the main body of an electrophotographic image forming device using an electrophotographic image forming process. The process cartridge is obtained by integrating the photosensitive drum and at least one of charging means, developing means, and cleaning means, or at least the developing means into a cartridge.

According to the process cartridge mode, the operability of the electrophotographic image forming device can be markedly improved because a user himself or herself can perform the maintenance of the device without depending on a serviceman. Accordingly, the process cartridge mode has been widely employed in electrophotographic image forming devices.

A general process cartridge will be described with reference to FIG. 8. A process cartridge generally includes the following three frame bodies:
1) a cleaning frame body 113 integrally supporting a photosensitive drum 107, a charging roller 108, and a cleaning blade 109;
2) a developing frame body 114 integrally supporting a developing roller 110 and a developing blade 112; and
3) a toner frame body 111 storing toner (specifically, the toner frame body is constituted of a toner upper frame body 111a and a toner lower frame body 111b).

In general, the above-mentioned frame bodies and other parts constituting the process cartridge are joined with each other by, for example, screws, resin joining (i.e., fixing through the injection of a molten resin), or ultra sonic welding. However, a conventional joining technique involves the following problem.

Description will be made with reference to FIG. 10. When an attempt is made to fasten the cleaning frame body 113 and a drum bearing 138 with screws X, the frame body and the bearing are joined with each other only at a joining portion d1, and cannot be joined with each other at a joining portion d2 owing to the absence of a space allowing them to be joined with each other at the portion d2, so an optimum range in which the frame body and the bearing are joined with each other cannot be secured at a preferable position in some cases.

In addition, an example of means for integrating the drum bearing 138 and the cleaning frame body 113 is to join the bearing and the frame body with each other at wide, annular (or arc-shaped) portions (that is, the joining portions d1 and d2) around an axial portion of the photosensitive drum 107 through the injection of a molten resin or the injection of a hot melt. However, in the joining through the injection of a molten resin or the injection of a hot melt, pressure is increased in order that a high-temperature injection material may be injected into each of the joining portions, and, furthermore, an injection material having high viscosity may be injected into each of the joining portions, so the joining involves a problem in that the surroundings of the joining portions are apt to deform owing to heat or pressure. Alternatively, the suppression of the deformation of those joining portions requires a large tool maintaining the drum bearing 138 and the cleaning frame body 113 in some cases.

Further description will be made with reference to FIG. 9. The toner lower frame body 111b as a container filled with a toner t and the toner upper frame body 111a are joined with each other by ultrasonic welding in some cases in order to obtain a toner frame body unit. The toner t may fly to scatter toward the outside of the container owing to a vibration generated in the joining by ultrasonic welding, so a cleaning step of removing the scattered toner is needed in some cases. In addition, ultrasonic welding requires the provision of a convex shape (i.e., welding rib 111a2) to be welded, and the provision of the vicinity of the welding rib with “flanges” referred to as flanges 111a1 and 111b1. The flanges generate a waste space 112 not needed for a product function, and the generation inhibits a reduction in size of a cartridge.

A laser welding method of performing welding by using laser light has started to be employed in welding plastics these days (see, for example, JP 2001-71384 A). Brief description of the laser welding method will be made hereinbelow.

A transmission resin layer through which laser light is transmitted and an absorption resin layer that absorbs laser light are fixed to each other under a predetermined pressure before laser light is applied from the side of the transmission resin layer. The laser light that has transmitted through the transmission resin layer is absorbed on the side of the absorption resin layer, and is transformed into heat. The absorption resin layer is melted by the heat, and, furthermore, the transmission resin layer is also melted by thermal conduction on the side of the absorption resin layer. After that, the transmission resin layer and the absorption resin layer are cooled and joined with each other.

The transmission resin layer must permit laser light to transmit through the layer while the absorption resin layer must absorb laser light. Accordingly, the selection of raw materials and coloring materials for the layers in accordance with properties needed for the layers is requested. The coloring materials are classified into a pigment coloring material and a dye coloring material. However, a coloring material to be incorporated into the transmission resin layer is generally expensive, so a cost for a part increases. In addition, the dye coloring material generally has so poor thermal stability that the material changes its color or generates a gas at the time of molding in some cases.

### SUMMARY OF THE INVENTION

An object of the present invention is to provide a cartridge and a toner container each of which hardly increases a material cost and is excellent in impact resistance against, for example, a vibration or a fall, the impact resistance being a needed function, as compared to a conventional cartridge. The cartridge and the toner container each cause nearly no deformation of the surroundings of a joining portion and nearly no temperature increase of the surroundings, and are each produced by employing a laser welding method as a joining method imposing a small number of restrictions on joining sites.

That is, the present invention is as described below.

[1] A cartridge, which is freely detachable from a main body of an electrophotographic image forming device, the cartridge including at least a first part and a second part joined with each other through a joining surface, characterized in that: the first part and the second part are welded and fixed to each other in at least a part of the joining surface through irradiation with laser light; the first part is molded out of a styrene resin composition (A1) containing at least a rubber-like polymer (a1) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A1) and having a thickness of 2 mm is 5% or less; and the second part is molded out of a styrene resin composition (B1) containing at least a rubber-like polymer (b1) having a number average particle size of 0.5 to 3.0 μm in an amount of 3 parts by mass or more to less than 6 parts by mass with respect to 100 parts by mass of a styrene resin, and a transmittance of the laser light for a resin plate molded out of the styrene resin composition (B1) and having a thickness of 2 mm is 20% or more.

[2] A cartridge according to the item [1], characterized in that the styrene resin composition out of which the first part is molded contains carbon black having a number average particle size of 10 to 30 nm in an amount of 0.3 to 1.5 parts by mass with respect to 100 parts by mass of the styrene resin.

[3] A cartridge according to the item [1], characterized in that at least one of the styrene resin composition out of which the first part is molded and the styrene resin composition out of which the second part is molded contains a flame retardant in an amount of 4 to 18 parts by mass with respect to 100 parts by mass of the styrene resin.

[4] A cartridge according to the item [3], characterized in that the second part contains a phosphate flame retardant.

[5] A cartridge according to the item [4], characterized in that the second part contains a bromine flame retardant and is free of antimony trioxide.

[6] A cartridge according to the item [1], characterized in that the rubber-like polymers each include a polymer selected from the group consisting of polybutadiene, a styrene-butadiene copolymer, polyisoprene, a butadiene-isoprene copolymer, natural rubber, and an ethylene-propylene copolymer.

[7] A cartridge according to the item [1], characterized in that the wavelength of the laser light is 750 to 3,000 nm.

[8] A cartridge according to the item [1], characterized in that one of the first part and the second part is a cleaning frame body and the other is a drum bearing.

[9] A cartridge according to the item [1], characterized in that one of the first part and the second part is a toner upper frame body and the other is a toner lower frame body.

[10] A cartridge according to the item [1], characterized in that one of the first part and the second part is a toner frame body and the other is a developing frame body.

[11] A cartridge, which is freely detachable from a main body of an electrophotographic image forming device, the cartridge comprising at least a first part and a second part joined with each other through a joining surface, characterized in that: the first part and the second part are welded and fixed to each other in at least a part of the joining surface through irradiation with laser light; the first part is molded out of a styrene resin composition (A2) containing at least a rubber-like polymer (a2) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A2) and having a thickness of 2 mm is 5% or less; and the second part is molded out of a styrene resin composition (B2) containing at least a rubber-like polymer (b2) having a number average particle size of 0.08 to 0.3 μm in an amount of 6 to 13 parts by mass with respect to 100 parts by mass of a styrene resin, and a transmittance of the laser light for a resin plate molded out of the styrene resin composition (B2) and having a thickness of 2 mm is 20% or more.

[12] A cartridge according to the item [11], characterized in that the styrene resin composition out of which the first part is molded contains carbon black having a number average particle size of 10 to 30 nm in an amount of 0.3 to 1.5 parts by mass with respect to 100 parts by mass of the styrene resin.

[13] A cartridge according to the item [11], characterized in that at least one of the styrene resin composition out of which the first part is molded and the styrene resin composition out of which the second part is molded contains a flame retardant in an amount of 4 to 18 parts by mass with respect to 100 parts by mass of the styrene resin.

[14] A cartridge according to the item [13], characterized in that the second part contains a phosphate flame retardant.

[15] A cartridge according to the item [14], characterized in that the second part contains a bromine flame retardant and is free of antimony trioxide.

[16] A cartridge according to the item [11], characterized in that the rubber-like polymers each comprise a polymer selected from the group consisting of polybutadiene, a styrene-butadiene copolymer, polyisoprene, a butadiene-isoprene copolymer, natural rubber, and an ethylene-propylene copolymer.

[17] A cartridge according to the item [11], characterized in that the wavelength of the laser light is 750 to 3,000 nm.

[18] A cartridge according to the item [11], characterized in that one of the first part and the second part is a cleaning frame body and the other is a drum bearing.

[19] A cartridge according to the item [11], characterized in that one of the first part and the second part is a toner upper frame body and the other is a toner lower frame body.

[20] A cartridge according to the item [11], characterized in that one of the first part and the second part is a toner frame body and the other is a developing frame body.

[21] A process for manufacturing a cartridge, which is freely detachable from a main body of an electrophotographic image forming device, the cartridge comprising at least a first part and a second part joined with each other through a joining surface, comprising: a step for welding and fixing the first part and the second part to each other through irradiation with laser light; the first part is molded out of a styrene resin composition (A1) containing at least a rubber-like polymer (a1) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A1) and having a thickness of 2 mm is 5% or less; and the second part is molded out of a styrene resin composition (B1) containing at least a rubber-like polymer (b1) having a number average particle size of 0.5 to 3.0 μm in an amount of 3 parts by mass or more to less than 6 parts by mass with respect to 100 parts by mass of a styrene resin, and a transmittance of the laser light for a resin plate molded out of the styrene resin composition (B1) and having a thickness of 2 mm is 20% or more.

[22] The process for manufacturing a cartridge according to the item [21], characterized in that the laser welding is applied through the irradiation with laser light from the second part toward the first part.

[23] The process for manufacturing a cartridge according to the item [21], characterized in that the wavelength of the laser light is 750 to 3,000 nm.

[24] The process for manufacturing a cartridge according to the item [21], characterized in that one of the first part and the second part is a cleaning frame body and the other is a drum hearing.

[25] The process for manufacturing a cartridge according to the item [21], characterized in that one of the first part and the second part is a toner upper frame body and the other is a toner lower frame body.

[26] The process for manufacturing a cartridge according to the item [21], characterized in that one of the first part and the second part is a toner frame body and the other is a developing frame body.

[27] A process for manufacturing a cartridge, which is freely detachable from a main body of an electrophotographic image forming device, the cartridge comprising at least a first part and a second part joined with each other through a joining surface, comprising: a step for welding and fixing the first part and the second part to each other through irradiation with laser light; the first part is molded out of a styrene resin composition (A2) containing at least a rubber-like polymer (a2) having a number average particle size of 0.5 to 3.0 82 m in an amount of 6 to 13 parts by mass with respect to 100 parts by mass of a styrene resin, and a transmittance of the laser light for a resin plate molded out of the styrene resin composition (A2) and having a thickness of 2 mm is 5% or less; and the second part is molded out of a styrene resin composition (B2) containing at least a rubber-like polymer (b2) having a number average particle size of 0.08 to 0.3 82 m in an amount of 6 to 13 parts by mass with respect to 100 parts by mass of a styrene resin, and a transmittance of the laser light for a resin plate molded out of the styrene resin composition (B2) and having a thickness of 2 mm is 20% or more.

[28] The process for manufacturing a cartridge according to the item [27], characterized in that the laser welding is applied through the irradiation with laser light from the second part side toward the first part. [29] The process for manufacturing a cartridge according to the item [27], characterized in that the wavelength of the laser light is 750 to 3,000 nm.

[30] The process for manufacturing a cartridge according to the item [27], characterized in that one of the first part and the second part is a cleaning frame body and the other is a drum bearing.

[31] The process for manufacturing a cartridge according to the item [27], characterized in that one of the first part and the second part is a toner upper frame body and the other is a toner lower frame body.

[32] The process for manufacturing a cartridge according to the item [27], characterized in that one of the first part and the second part is a toner frame body and the other is a developing frame body.

The cartridge of the present invention was obtained on the basis of the finding that the appropriate adjustment of the kind and amount of a material to be incorporated into each of resins of which the first part and the second part are formed can (1) adjust the laser light transmittance of each part to enable the laser welding of each part and (2) secure impact resistance or rigidity as one important product function of a cartridge.

The cartridge of the present invention was completed by paying particular attention to the fact that the light transmittance, impact resistance, and the like of the second part are affected by, for example, the particle size and amount of the rubber-like polymer in the laser light transmissive resin composition of which the second part is formed, and the kind of the flame retardant in the composition.

According to the present invention, there can be provided a cartridge which hardly increases a cost, is excellent in impact resistance, and is hardly susceptible to a vibration, a fall, or the like as compared to a conventional cartridge.

### BRIEF DESCRIPTION OF THE DRAWINGS

FIG. 1 is a perspective view of a cartridge in an embodiment of the present invention.

FIG. 2 is a main schematic sectional view of the cartridge in the embodiment of the present invention.

FIG. 3 is a main schematic sectional view of a main body of an electrophotographic image forming device in the embodiment of the present invention.

FIG. 4 is a perspective view schematically showing a partial constitution of the cartridge in the embodiment of the present invention.

FIG. 5 is a partial vertical sectional view of the cartridge in the embodiment of the present invention.

FIG. 6 is a partial vertical sectional view of the cartridge in the embodiment of the present invention.

FIG. 7 is a partial vertical sectional view of the cartridge in the embodiment of the present invention.

FIG. 8 is a main schematic sectional view of a conventional cartridge.

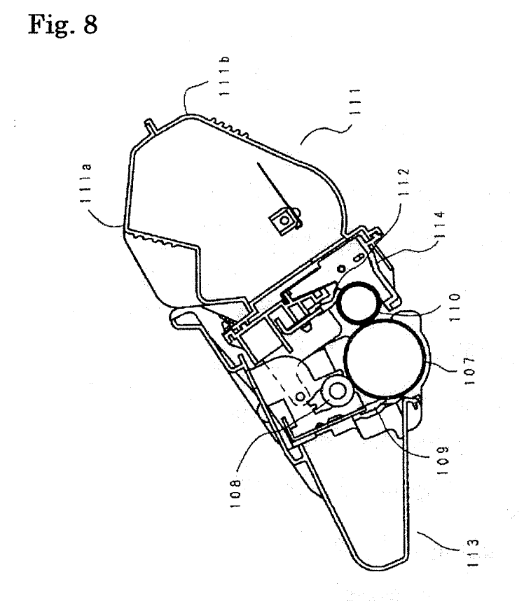

FIG. 9 is a partial vertical sectional view of the conventional cartridge.

FIG. 10 is a partial perspective view of the conventional cartridge.

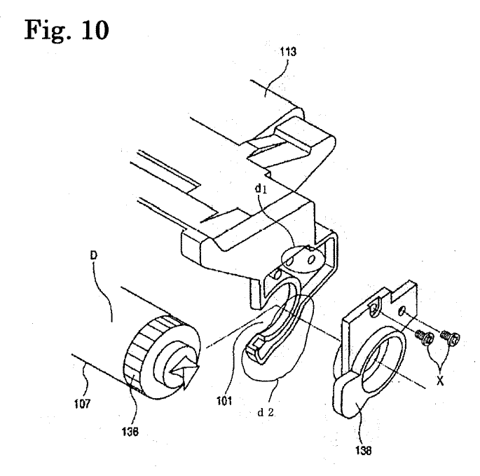

### DESCRIPTION OF THE EMBODIMENTS

A cartridge of the present invention includes at least a first part and a second part joined with each other through a joining surface. The first part and the second part in the cartridge of the present invention have only to be parts which are joined with and fixed to each other in an ordinary cartridge and each of which is molded out of a resin. In addition, each of the first part and the second part is preferably a resin plate, and the thickness of the resin plate is preferably about 1 to 2 mm.

Examples of the cartridge of the present invention and an electrophotographic image forming device including the cartridge (hereinafter referred to as “image forming device”) will be described in accordance with the attached figures. However, the cartridge of the present invention is not limited to a cartridge to be described below.

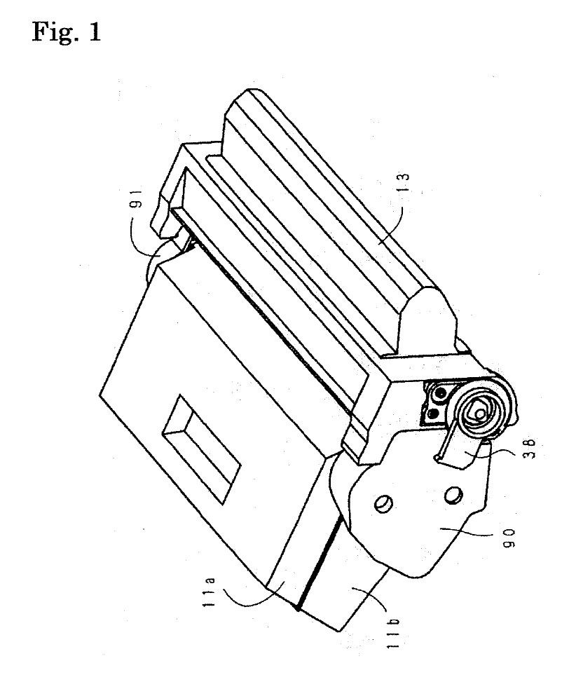

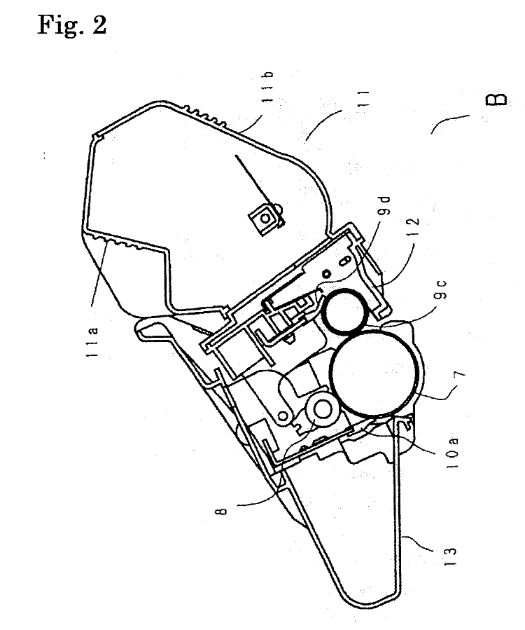

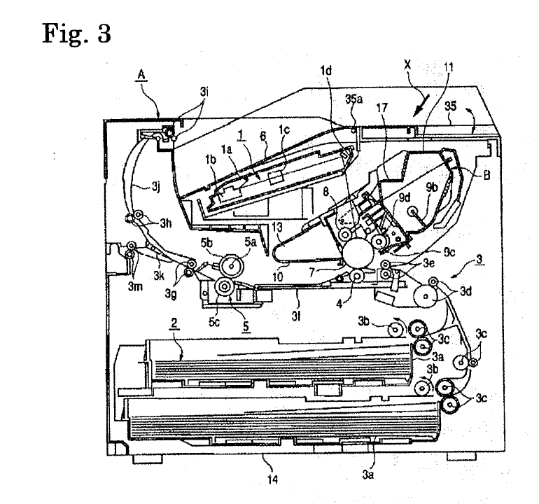

A cartridge including an image-bearing member and process means acting on the image-bearing member, and an image forming device including the cartridge will be described with reference to FIGS. 1 to 3. FIG. 1 shows a perspective view of the cartridge, FIG. 2 shows a main sectional view of the cartridge, and FIG. 3 shows a main sectional view of the image forming device including the cartridge.

The cartridge shown in each of FIGS. 1 to 3 includes an image-bearing member and process means acting on the image-bearing member. Examples of the process means to be used here include charging means for charging the surface of the image-bearing member, a developing device for forming a toner image on the image-bearing member, and cleaning means for removing toner remaining on the surface of the image-bearing member.

As shown in FIG. 2, the cartridge can be constituted of: a cleaning frame body 13 provided with an electrophotographic photosensitive drum (hereinafter referred to as “photosensitive drum”) 7 as an image-bearing member, a charging roller 8 as charging means, and a cleaning blade 10a as cleaning means; a developing frame body 12 integrally supporting a developing roller 9c and a developing blade 9d; and a toner frame body 11 storing toner (which is constituted of a toner upper frame body 11a and a toner lower frame body 11b)

As shown in FIG. 1, the cartridge can include a drum bearing 38 and side covers 90 and 91 covering a driving gear train (not shown) or the like on the side surface of at least one of the developing frame body 12 and the toner frame body 11.

The cartridge shown in each of FIGS. 1 and 2 is mounted on an image forming device A shown in FIG. 3 before the cartridge is used for forming an image.

A recording medium 2 is sent from a sheet feeding cassette 3a mounted on the lower portion of the device by a pickup roller 3b. Subsequently, the recording medium 2 is conveyed by conveying rollers 3c, and is then caused to wait at registration rollers 3e.

The photosensitive drum 7 is selectively exposed to light from an exposing device 1 in synchronization with the recording medium 2, whereby a latent image is formed on the drum. After that, the toner stored in the toner frame body 11 is formed into a thin layer by the developing blade 9d, and the developing roller 9c is caused to carry the thin layer on its surface. Then, a developing bias is applied to the developing roller 9c so that the toner is supplied to the photosensitive drum 7 in accordance with the latent image. Thus, a toner image is formed.

The recording medium 2 is conveyed from the registration rollers 3eto a portion where a transferring roller 4 and the photosensitive drum 7 are opposite to each other while the conveyance is timed to the formation of the toner image on the photosensitive drum 7. The toner image is transferred by the application of a bias voltage to the transferring roller 4 onto the recording medium 2 being conveyed. After the transfer, the residual toner on the photosensitive drum 7 is removed by cleaning means 10. Detailed description about the foregoing is as described below. The toner remaining on the photosensitive drum 7 is scraped by the cleaning blade 10a, and, at the same time, is scooped by a scooping sheet (not shown). The scraped toner is collected in a waste toner reservoir 10b, whereby cleaning is performed.

In addition, the recording medium 2 onto which the toner image has been transferred is conveyed to a fixing device 5 where the image is fixed to the medium. Then, the resultant medium is discharged to a discharge tray 6 on the upper portion of the device by sheet discharge rollers 3g, 3h, and 3i.

Examples of the combination of the first part and the second part in the cartridge of the present invention include, but not particularly limited to, the following four combinations:

(1) a cleaning frame body and a drum bearing;

(2) a toner upper frame body and a toner lower frame body;

(3) a toner frame body and a developing frame body; and

(4) a developing frame body and a toner frame body, or one of the frame bodies and a side cover.

The cartridge of the present invention is characterized in that each of the first part and the second part in the cartridge is molded out of a styrene resin composition. Each of the styrene resin compositions out of which the respective parts are molded contains at least a styrene resin as a base material resin and a rubber-like polymer.

Examples of the styrene resin in each of the styrene resin compositions include polystyrene and acrylonitrile butadiene styrene (ABS). Of those, polystyrene is preferable.

Examples of the rubber-like polymer in each of the styrene resin compositions include polybutadiene, a styrene-butadiene copolymer, polyisoprene, a butadiene-isoprene copolymer, natural rubber, and an ethylene-propylene copolymer, and a combination of two or more of them. Of those, a styrene-butadiene copolymer is preferable.

A styrene resin composition containing a styrene resin and a rubber-like polymer is referred to as high-impact polystyrene (HIPS) as a rubber-denatured styrene material in some cases. The HIPS is a resin composition with improved impact resistance obtained by mixing polystyrene (PS) which is inexpensive and has good flowability with any one of rubber-like polymers (including rubber-like copolymers).

Each of the resin compositions out of which the first part and the second part in the cartridge of the present invention are molded may contain a flame retardant. In addition, the resin composition out of which the first part is molded may contain carbon black.

The cartridge of the present invention is characterized in that the transmittance of laser light having a wavelength of 750 to 3,000 nm for a resin plate which: is molded out of a resin composition (A) out of which the first part in the cartridge is molded; and has a thickness of 2 mm is 5% or less. That is, the first part acts as a laser light absorptive resin part in laser welding to be described later.

In the specification, a method of measuring the transmittance of laser light for a resin plate is as described below.

That is, a member whose transmittance is to he measured is irradiated with laser light at a predetermined output (W), and a power meter is mounted on the side opposite to the side irradiated with the laser light so that an input (W) is read. Then, a ratio of the input to the output is specified as the transmittance of the member, whereby the transmittance of the laser light for a resin plate can be measured.

A power meter PW-250 manufactured by SYNRAD, Inc. was used in this investigation.

The transmittance of laser light for the resin composition (A) out of which the first part is molded is controlled by adjusting the content and shape of a rubber-like polymer (a) in the resin composition (A).

The content of the rubber-like polymer (a) in the resin composition (A) is 6 to 13 parts by mass with respect to 100 parts by mass of a styrene resin. When the content is less than 6 parts by mass, it is difficult to set the transmittance of laser light to 5% or less, and the impact resistance of the first part reduces in some cases. On the other hand, when the content exceeds 13 parts by mass, the welding strength between the parts reduces in some cases.

In addition, the rubber-like polymer (a) in the resin composition (A) is particulate, and has a number average particle size of 0.5 to 3.0 μm. The number average particle size is preferably 1.5 to 3.0 μm. The number average particle size of the rubber-like polymer (a) means the number average value of area-equivalent diameters determined from an SEM image.

As described above, the styrene resin composition of which the first part is formed may contain carbon black. The content of carbon black is preferably 0.3 to 1.5 parts by mass with respect to 100 parts by mass of the styrene resin composition, and the number average particle size of carbon black is preferably 10 to 30 nm. This is because the quantity of heat to be generated from the part is optimized when the content and the number average particle size are within the ranges. The number average particle size of carbon black means the number average value of area-equivalent diameters determined from an SEM image.

The cartridge of the present invention is characterized in that the transmittance of laser light having a wavelength of 750 to 3,000 nm for a resin plate which: is molded out of a resin composition (B) out of which the second part in the cartridge is molded; and has a thickness of 2 mm is 20% or more. That is, the second part acts as a laser light transmissive resin part in the laser welding to be described later.

The transmittance of laser light for the resin composition (B) out of which the second part is molded is controlled by adjusting the content and shape of a rubber-like polymer (b) in the resin composition (B).

A preferable combination of the content and number average particle size of the rubber-like polymer (b) in the resin composition (B) is as described below.
1) The content of the rubber-like polymer (b) in the resin composition (B) is in the range of 3 parts by mass or more to less than 6 parts by mass with respect to 100 parts by mass of a styrene resin, and the number average particle size of the rubber-like polymer (b) is 0.5 to 3.0 μm.
2) The content of the rubber-like polymer (b) in the resin composition (B) is 6 to 13 parts by mass with respect to 100 parts by mass of the styrene resin, and the number average particle size of the rubber-like polymer (b) is 0.08 to 0.3 82 m. The number average particle size of the rubber-like polymer (b) is defined in the same manner as in the case of the number average particle size of the rubber-like polymer (a).

The content of the rubber-like polymer having a number average particle size of 0.5 to 3.0 μm is in the range of 3 parts by mass or more to less than 6 parts by mass with respect to 100 parts by mass of the styrene resin. When the content is 6 parts by mass or more, the transparency and transmission property of a styrene resin composition to be obtained are so poor that it becomes hard to control the transmission property of laser light for the second part in an appropriate manner. On the other hand, when the content is less than 3 parts by mass, the impact resistance of the second part is so poor that it becomes difficult to use the part in any one of containers of a cartridge.

In addition, when the content of the rubber-like polymer is 6 to 13 parts by mass with respect to 100 parts by mass of the styrene resin, the number average particle size of the rubber-like polymer is 0.08 to 0.3 μm. When the number average particle size exceeds 0.3 μm, the transparency and transmission property of a styrene resin composition to be obtained are so poor that the laser light transmission property of the second part is not appropriately controlled. On the other hand, when the number average particle size is less than 0.08 μm, the impact resistance of the second part is so poor that it becomes difficult to use the part in any one of containers of a cartridge.

As described above, each of the styrene resin compositions of which the first part and the second part are formed may contain a flame retardant. In this case, safety against fire is improved. In particular, a frame body (container) material for a cartridge is requested to have the flame retardancy of UL 94-V2 according to a UL standard as safety against fire. To this end, a styrene resin composition out of which each part is molded preferably contains, as a first flame retardant, a bromine flame retardant (such as ethylene bispentabromobenzene, a tetrabromobisphenol A derivative, or a polybrominated aliphatic ether derivative) or a phosphate flame retardant (such as resorcinol bis(diphenylphosphate) or bisphenol A bis(diphenylphosphate).

Further, the styrene resin compositions out of one of which the first part or the second part is molded can each contain the first flame retardant and a second flame retardant in combination. A combination with the second flame retardant can not only reduce the content of the first flame retardant but also prevent the heat resistance of each of the styrene resin compositions from reducing.

Examples of the second flame retardant to be combined with the first flame retardant include the following flame retardants.
(1) When the first flame retardant is a bromine flame retardant, antimony trioxide can be preferably used as the second flame retardant. However, it is not preferable to incorporate antimony trioxide into the resin composition of which the second part is formed (i.e., light transmissive resin composition) because antimony trioxide reduces the laser light transmission property of a resin composition containing antimony trioxide.

For example, the transmittance of laser light having a wavelength of 940 nm for a resin plate (having a thickness of 2 mm) molded out of a resin composition which: contained 8 parts by mass of a bromine flame retardant (ethylene bispentabromobenzene, trade name; Saytex 8010 of ALBEMARLE ASANO CORPORATION) with respect to 100 parts by mass of a styrene resin; and was free of antimony trioxide was 50% while the transmittance of laser light having a wavelength of 940 nm for a resin plate (having a thickness of 2 mm) molded out of a resin composition containing 6.5 parts by mass of a bromine flame retardant (ethylene bispentabromobenzene, trade name; Saytex 8010 of ALBEMARLE ASANO CORPORATION) and 1.5 parts by mass of antimony trioxide with respect to 100 parts by mass of a styrene resin was 19%.

(2) When the first flame retardant is a phosphate flame retardant, a polyphenylene ether (PPE) resin can be preferably used as the second flame retardant. In this case, the PPE resin is added in an amount of 9 to 17 parts by mass with respect to 100 parts by mass of the styrene resin.

The cartridge of the present invention, which has the first part and the second part joined with each other through the joining surface as described above, is characterized in that both the parts are subjected to laser welding in at least a part of the joining surface.

Brief description of the laser welding is given here. The first part formed of a laser light absorptive resin composition and the second part formed of a laser light transmissive resin composition are fixed to each other under a given pressure. For example, both the parts can be fixed to each other by bonding their vicinities with screws. Laser light is applied from the second part (formed of the light transmissive resin composition). The laser light that has passed the second part is absorbed by the first part (formed of the light absorptive resin composition). The absorbed laser light is transformed into heat thereby generating heat. The resin of which the first part is formed is melted by the heat, and, furthermore, the resin of which the second part is formed is also melted by thermal conduction. After that, both the parts are cooled and welded to each other.

Examples of the laser light to be used in the laser welding include semiconductor laser, glass:neodymium³⁺ laser, YAG:neodymium³⁺ laser, ruby laser, helium-neon laser, krypton laser, argon laser, H₂ laser, and N₂ laser. Of those, semiconductor laser is preferable.

The wavelength of the laser light to be used in the laser welding is preferably in a near infrared region (750 to 3,000 nm). In addition, the output of the laser light to be used in the laser welding is preferably 100 W or less.

The laser welding in the present invention can be performed by using, for example, a laser welding machine having the following specifications.

Kind of laser light: semiconductor laser, wavelength: 940 nm, output: 30 W, laser spot diameter: 0.6 mm, diameter of laser light with which a joining portion is irradiated: 1.2 mm

The cartridge of the present invention can be produced by an ordinary method except that: the first part and the second part arbitrarily selected from the frame bodies and components of the cartridge are molded out of a laser light absorptive resin composition and a laser light transmissive resin composition, respectively; and the parts are subjected to laser welding.

As described above, examples of the combination of the first part and the second part in the cartridge in the present invention include the following four combinations:

(1) a cleaning frame body and a drum bearing;

(2) a toner upper frame body and a toner lower frame body;

(3) a toner frame body and a developing frame body; and

(4) a developing frame body and a toner frame body, or one of the frame bodies and a side cover.

Hereinafter, laser welding concerning any one of the combinations described in the above items (1) to (3) will be described more specifically.

(1) Laser Welding of Cleaning Frame Body and Drum Bearing

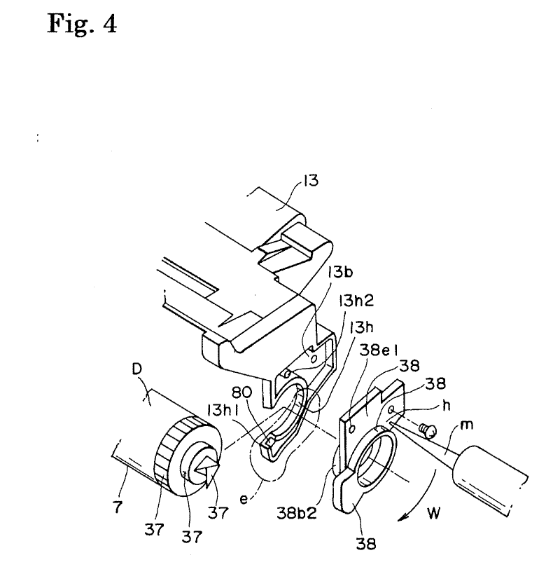

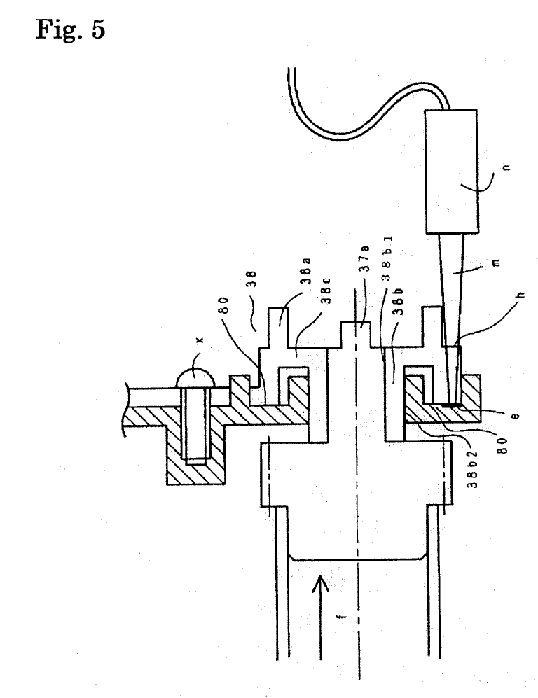

FIG. 4 is a perspective view showing an installation relationship between the drum bearing 38 supporting a photosensitive drum and the cleaning frame body 13. FIG. 5 is a partial vertical sectional view showing the installation relationship between the drum bearing 38 and the cleaning frame body 13. The installation of the drum bearing 38 on the cleaning frame body 13 and the installation of a photosensitive drum unit D provided as a unit on the cleaning frame body 13 will be described specifically.

Here, the cleaning frame body 13 corresponds to the first part (formed of the laser light absorptive resin composition) while the drum bearing 38 corresponds to the second part (formed of the laser light transmissive resin composition).

The drum bearing 38 is integrally provided with a large-diameter protruding portion 38a and a small-diameter protruding portion 38b concentric with the protruding portion 38a (see FIGS. 4 and 5). The small-diameter protruding portion 38b is connected to an end portion of a disk portion 38c at the intermediate portion in the axial direction (i.e., longitudinal direction) of the large-diameter protruding portion 38a.

As shown in FIG. 4, a side wall 13b of the cleaning frame body 13 is provided with an installation hole 13h into which an outer peripheral portion 38b2 of the small-diameter protruding portion of the drum bearing 38 is inserted. An interval between the opposite ends of a circular arc portion 13h1 is smaller than the diameter of the installation hole 13h and larger than the diameter of a coupling convex shaft 37.

In addition, the coupling convex shaft 37 engages with an inner peripheral portion 38b1 of the small-diameter protruding portion 38b of the drum bearing 38. A positioning pin 13h2 integrally formed with and provided for the side wall 13b of the cleaning frame body 13 closely engages with a hole 38e1 provided for the drum bearing 38. In addition, the longitudinal position of each of the drum bearing 38 and the cleaning frame body 13 is determined by an abutting surface (i.e., reference) 80.

In view of the foregoing, the photosensitive drum 7 provided as a unit can be installed on the cleaning frame body 13 from a direction intersecting the axial direction (i.e., longitudinal direction), and, at the same time, the position of the drum bearing 38 relative to the cleaning frame body 13 is determined when the drum bearing 38 is installed on the cleaning frame body 13 from the longitudinal direction.

The photosensitive drum 7 provided as a unit can be installed on the cleaning frame body 13 as shown in FIG. 4 by: moving the photosensitive drum 7 in the direction intersecting the longitudinal direction; causing the coupling convex shaft 37 of the photosensitive drum 7 to pass the circular arc portion 13h1 to be inserted into the bearing installation hole 13h; and providing a drum gear 37b for the inside of the cleaning frame body 13. In this state, the drum bearing 38 is moved in the axial direction so that the small-diameter protruding portion 38b is engaged with the coupling convex shaft 37, and the bearing is further moved in the axial direction so that the small-diameter protruding portion 38b is engaged with the bearing installation hole 13h of the cleaning frame body 13, followed by screwing. Thus, the drum bearing 38 and a joining surface e of the cleaning frame body 13 are brought into close contact with each other.

The photosensitive drum 7 provided as a unit is screwed on the cleaning frame body 13. Further, a laser head n is moved in a direction indicated by an arrow W (shown in FIG. 4) while laser light m is applied onto a surface h of the drum bearing 38, whereby both the parts are welded to each other in a part of the joining surface e.

The cleaning frame body 13 and the drum bearing 38 which have been subjected to laser welding are subjected to laser welding at a width of only about 1.2 mm in the joining surface e, so the temperature increase of the surroundings of the portion where they are welded to each other is suppressed, and the deformation or the like of the surroundings of the portion does not occur. In contrast, when a predetermined amount of a molten resin, a hot melt, or the like is injected into a joining portion (i.e., gap) so that they are joined with each other, the temperature at the joining portion is apt to increase, and the increase is apt to cause the deformation or the like of the surroundings of the portion.

Further, the cleaning frame body 13 and the drum bearing 38 are subjected to laser welding, whereby they can be joined with each other in a wide range and in a region where they cannot have been conventionally joined with each other (i.e., the arc-shaped region e; see a broken line portion of FIG. 4 and a thick line portion of FIG. 5). As a result, the cleaning frame body and the drum bearing are integrated with each other to improve rigidity.

A coupling convex portion 37a of the photosensitive drum 7 and a coupling concave portion (not shown) of the main body of an image forming device each have a “twist shape”. The “twist shape” acts as a member for transferring the driving force of the photosensitive drum. When a cartridge including the photosensitive drum 7 is mounted on the main body of the image forming device, the force (in a direction indicated by an arrow f of FIG. 5) with which the coupling concave portion (not shown) of the main body of the device attracts the convex portion 37a is generated. As a result, a biasing force for abutting the side wall 13b of the cleaning frame body 13 against the inner wall (not shown) of the main body of the device is generated.

The deformation of the side wall 13b due to the biasing force can be suppressed because the cleaning frame body 13 and the drum bearing 38 are integrated with each other to improve the rigidity of the side wall 13b in the cartridge of the present invention in which the cleaning frame body 13 and the drum bearing 38 are joined with each other by laser welding. Therefore, the deviation of the center of the rotation axis of the photosensitive drum 7 is suppressed, and the photosensitive drum 7 can stably rotate. Further, the accuracy with which a cartridge B is positioned with respect to the main body of the device is improved because the rigidity of the side wall 13b of the portion where the drum bearing 38 having the large-diameter protruding portion 38a is installed on the cleaning frame body 13 improves.

(2) Laser Welding of Toner Upper Frame Body and Toner Lower Frame Body

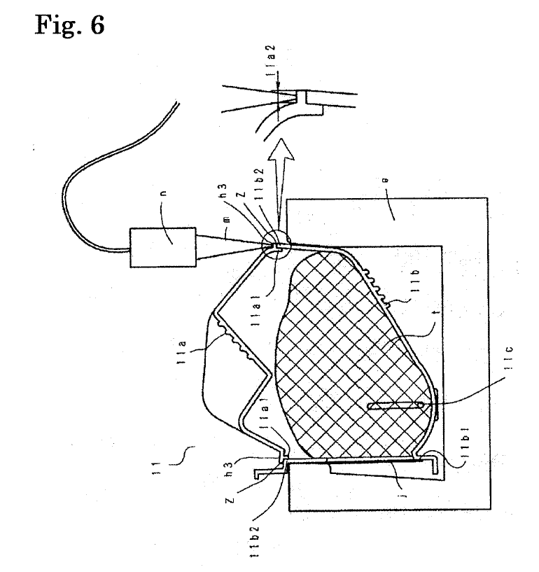

Next, a procedure for assembling a toner frame body unit will be described with reference to FIG. 6. The toner frame body 11 is constituted of the toner upper frame body 11a and the toner lower frame body 11b. Here, the toner lower frame body 11b is the first part formed of the laser light absorptive resin composition while the toner upper frame body 11a is the second part formed of the laser light transmissive resin composition.

A toner seal j is thermally welded to a surface 11b1 of the toner lower frame body 11b. The toner seal j seals the toner t with which the inside of the frame body is filled in the toner frame body to prevent the toner t from moving toward the side of the developing frame body 12 (described later) until a cartridge is used.

First, the toner lower frame body 11b provided with a sending member 11c for stirring toner is set in a jig g. Further, the toner lower frame body 11b is filled with a predetermined amount of the toner t.

After that, a flange 11a1 of the toner upper frame body 11a is inserted into a tip 11b2 of an opening of the toner lower frame body 11b so that the toner upper frame body 11a is mounted on the toner lower frame body 11b. Thus, the position of each of the toner upper frame body 11a and the toner lower frame body 11b in the lateral direction in the figure is determined. At that time, the toner upper frame body and the toner lower frame body are brought into close contact with each other in the entire region of a joining portion z.

After that, laser light is applied to the joining portion z where the toner upper frame body 11a and the toner lower frame body 11b are to be joined with each other from above a surface h3 of the toner upper frame body 11a molded out of the laser light transmissive resin composition, whereby the frame bodies are joined with each other by welding.

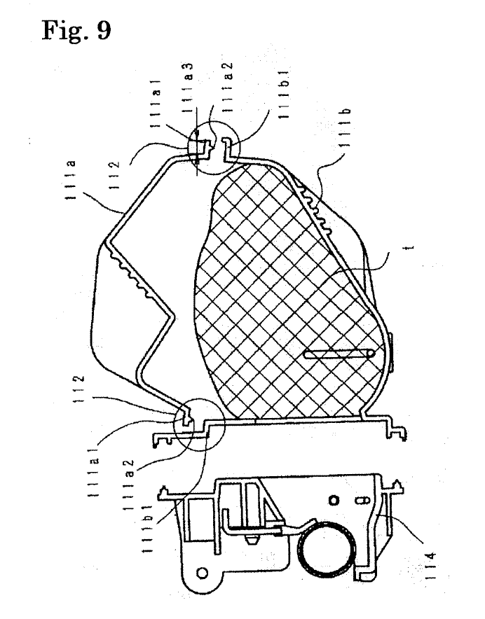

The toner upper frame body 11a and the toner lower frame body 11b have been conventionally joined with each other by ultrasonic welding. As shown in FIG. 9, this case has involved the need for pressurizing or vibrating the flange 111a1 on the welding rib 111a2 by using a horn (not shown) of a welding machine to dissolve the welding rib 111a2. Therefore, the case has required a flange width 111a3 of about 6.0 mm.

On the other hand, when the toner upper frame body 11a and the toner lower frame body 11b are joined with each other by a laser welding method, the frame bodies have only to be brought into close contact with each other at the joining portion z by pressurizing any site of the toner upper frame body 11a toward the side of the toner lower frame body 11b (i.e., lower side in FIG. 6) as shown in FIG. 6. Accordingly, a flange width 11a2 has only to be the irradiation width of laser light to be applied, and can be about 1.8 mm. Therefore, according to simple calculation, the length of a cartridge in a direction perpendicular to the longitudinal direction of the cartridge can be shortened by about 4.2 mm, and the size of the cartridge can be reduced.

(3) Laser Welding of Toner Frame Body and Developing Frame Body

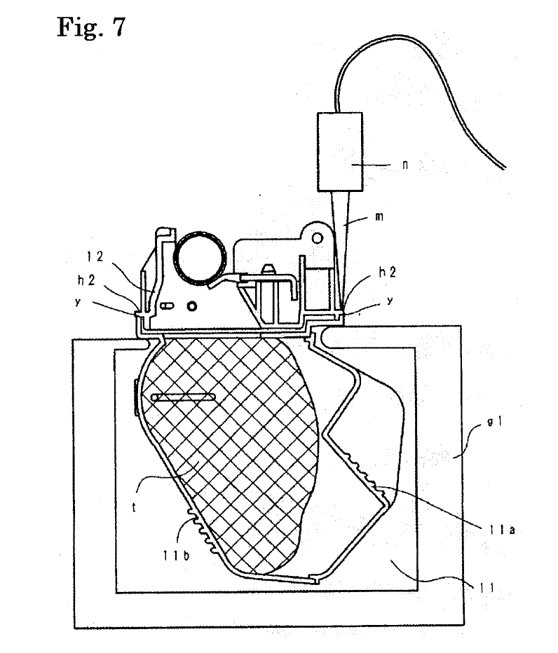

As shown in FIG. 7, the toner frame body 11 and the developing frame body 12 are brought into close contact with each other at a joining portion y as in the case of Embodiment (2) described above. Here, the toner frame body 11 is the first part formed of a laser light absorptive material while the developing frame body 12 is the second part formed of a laser light transmissive material.

The toner frame body 11 and the developing frame body 12 are set in a jig g1. Further, both the frame bodies are brought into close contact with each other at the joining portion y by using another jig (not shown). Laser light is applied from above a surface h2 on the side of the developing frame body 12, whereby the toner frame body 11 and the developing frame body 12 can be joined with each other by welding.

### EXAMPLES

Hereinafter, Embodiments (1) to (3) of joining described above as well as the detailed prescription of each material will be described in more detail.

### Example 1

The drum bearing 38 and the cleaning frame body 13 shown below were joined with each other by a laser welding method on the basis of Embodiment (1). The specifications of a laser welding machine used in the laser welding are as described below.

Kind of laser light: semiconductor laser, wavelength: 940 nm, output: 30 W, laser spot diameter: 0.6 mm, diameter of laser light with which a joining portion is irradiated: 1.2 mm

The drum bearing 38 was formed of a laser light transmissive resin composition shown below. The thickness of the drum hearing 38 at a portion to he irradiated with laser light was set to 1.5 mm. The term “laser light transmittance” in the table means the transmittance of semiconductor laser light having a wavelength of 940 nm for a resin plate molded out of the laser light transmissive resin composition and having a thickness of 2 mm.

TABLE 1
Laser light transmissive resin composition

| | Polystyrene (having a weight average |
|---|---|
| Base material resin | molecular weight of 9 × 10⁴) |
| Coloring material | None |
| Rubber-like polymer | Polybutadiene |
| | Content: 4 parts by mass with respect |
| | to 100 parts by mass of polystyrene |
| | Number average particle size: 1.8 μm |
| Flame retardant | Phosphate |
| | (Aromatic condensed phosphate, trade |
| | name: CR 741 manufactured by DAIHACHI |
| | CHEMICAL INDUSTRY CO., LTD.) |
| | Content: 8 parts by mass with respect |
| | to 100 parts by mass of polystyrene |
| Laser light | 40% |
| transmittance | |
| (Thickness 2 mm) | |

The cleaning frame body 13 was formed of a laser light absorptive resin composition shown below.

TABLE 2
Laser light absorptive resin composition

| | Polystyrene (having a weight average |
|---|---|
| Base material resin | molecular weight of 9 × 10⁴) |
| Coloring material | Carbon black |
| | Content: 0.7 part by mass with respect |
| | to 100 parts by mass of polystyrene |
| | Number average particle size: 16 nm |
| Rubber-like polymer | Polybutadiene |
| | Content: 8 part by mass with respect to |
| | 100 parts by mass of polystyrene |
| | Number average particle size: 1.8 μm |
| Flame retardant | Phosphate |
| | (Aromatic condensed phosphate, trade |
| | name: CR 741 manufactured by DAIHACHI |
| | CHEMICAL INDUSTRY CO., LTD.) |
| | Content: 8 part by mass with respect to |
| | 100 parts by mass of polystyrene |
| Laser light | 0.5% |
| transmittance | |
| (Thickness 2 mm) | |

### Example 2

The toner upper frame body 11a and the toner lower frame body 11b were joined with each other by a laser welding method on the basis of Embodiment (2), whereby a toner container was produced. A laser welding machine having the same specifications as those of Example 1 was used.

The toner upper frame body 11a was formed of a laser light transmissive resin composition shown below.

TABLE 3
Laser light transmissive resin composition

| | Polystyrene (having a weight average |
|---|---|
| Base material resin | molecular weight of 9 × 10⁴) |
| Coloring material | None |
| Rubber-like polymer | Polybutadiene |
| | Content: 8 parts by mass with respect |
| | to 100 parts by mass of polystyrene |
| | Number average particle size: 0.15 μm |
| Flame retardant | Phosphate |
| | (Aromatic condensed phosphate, trade |
| | name: CR 141 manufactured by DAIHACHI |
| | CHEMICAL INDUSTRY CO., LTD.) |
| | Content: 8 parts by mass with respect |
| | to 100 parts by mass of polystyrene |
| Laser light | 80% |
| transmittance | |
| (Thickness 2 mm) | |

The toner lower frame body 11b was formed of a laser light absorptive resin composition shown below.

TABLE 4
Laser light absorptive resin composition

| | Polystyrene (having a weight average |
|---|---|
| Base material resin | molecular weight of 9 × 10⁴) |
| Coloring material | Carbon black |
| | Content: 0.7 part by mass with respect |
| | to 100 parts by mass of polystyrene |
| | Number average particle size: 16 nm |
| Rubber-like polymer | Polybutadiene |
| | Content: 8 part by mass with respect to |
| | 100 parts by mass of polystyrene |
| | Number average particle size: 1.8 μm |
| Flame retardant | Phosphate |
| | (Aromatic condensed phosphate, trade |
| | name: CR 741 manufactured by DAIHACHI |
| | CHEMICAL INDUSTRY CO., LTD.) |
| | Content: 8 part by mass with respect to |
| | 100 parts by mass of polystyrene |
| Transmittance | 0.5% |
| (Thickness 2 mm) | |

### Example 3

The developing frame body 12 and the toner lower frame body 11b were joined with each other by a laser welding method on the basis of Embodiment (3). A laser welding machine having the same specifications as those of Example 1 was used.

The developing frame body 12 was formed of a laser light transmissive resin composition shown below.

TABLE 5
Laser light transmissive resin composition

| | Polystyrene (having a weight average |
|---|---|
| Base material resin | molecular weight of 9 × 10⁴) |
| Coloring material | None |
| Rubber-like polymer | Polybutadiene |
| | Content: 8 parts by mass with respect |
| | to 100 parts by mass of polystyrene |
| | Number average particle size: 0.15 μm |
| Flame retardant | Phosphate |
| | (Aromatic condensed phosphate, trade |
| | name: CR 741 manufactured by DAIHACHI |
| | CHEMICAL INDUSTRY CO., LTD.) |
| | Content: 8 parts by mass with respect |
| | to 100 parts by mass of polystyrene |
| Laser light | 80% |
| transmittance | |
| (Thickness 2 mm) | |

The toner lower frame body 11b was formed of the laser light absorptive resin composition of Example 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. JP 2005-294620, filed Oct. 7, 2005, which is hereby incorporated by reference herein in its entirety.

What is claimed is:

1. A cartridge, which is freely detachable from a main body of an electrophotographic image forming device, the cartridge comprising at least a first part and a second part joined with each other through a joining surface, wherein:
the first part and the second part are welded and fixed to each other in at least a part of the joining surface through irradiation with laser light;
the first part is molded out of a styrene resin composition (A1) containing at least a rubber-like polymer (a1) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A1) and having a thickness of 2 mm is 5% or less; and
the second part is molded out of a styrene resin composition (B1) containing at least a rubber-like polymer (b1) having a number average particle size of 0.5 to 3.0 μm in an amount of 3 parts by mass or more to less than 6 parts by mass with respect to 100 parts by mass of a styrene resin, and a transmittance of the laser light for a resin plate molded out of the styrene resin composition (B1) and having a thickness of 2 mm is 20% or more.

2. A cartridge according to claim 1, wherein the styrene resin composition out of which the first part is molded contains carbon black having a number average particle size of 10 to 30 nm in an amount of 0.3 to 1.5 parts by mass with respect to 100 parts by mass of the styrene resin.

3. A cartridge according to claim 1, wherein at least one of the styrene resin composition out of which the first part is molded and the styrene resin composition out of which the second part is molded contains a flame retardant in an amount of 4 to 18 parts by mass with respect to 100 parts by mass of the styrene resin.

4. A cartridge according to claim 3, wherein the second part contains a phosphate flame retardant.

5. A cartridge according to claim 4, wherein the second part contains a bromine flame retardant and is free of antimony trioxide.

6. A cartridge according to claim 1, wherein the rubber-like polymers each comprise a polymer selected from the group consisting of polybutadiene, a styrene-butadiene copolymer, polyisoprene, a butadiene-isoprene copolymer, natural rubber, and an ethylene-propylene copolymer.

7. A cartridge according to claim 1, wherein the wavelength of the laser light is 750 to 3,000 nm.

8. A cartridge according to claim 1, wherein one of the first part and the second part is a cleaning frame body and the other is a drum bearing.

9. A cartridge according to claim 1, wherein one of the first part and the second part is a toner upper frame body and the other is a toner lower frame body.

10. A cartridge according to claim 1, wherein one of the first part and the second part is a toner frame body and the other is a developing frame body.

11. A cartridge, which is freely detachable from a main body of an electrophotographic image forming device, the cartridge comprising at least a first part and a second part joined with each other through a joining surface, wherein:
the first part and the second part are welded and fixed to each other in at least a part of the joining surface through irradiation with laser light;
the first part is molded out of a styrene resin composition (A2) containing at least a rubber-like polymer (a2) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A2) and having a thickness of 2 mm is 5% or less; and
the second part is molded out of a styrene resin composition (B2) containing at least a rubber-like polymer (b2) having a number average particle size of 0.08 to 0.3 μm in an amount of 6 to 13 parts by mass with respect to 100 parts by mass of a styrene resin, and a transmittance of the laser light for a resin plate molded out of the styrene resin composition (B2) and having a thickness of 2 mm is 20% or more.

12. A cartridge according to claim 11, wherein the styrene resin composition out of which the first part is molded contains carbon black having a number average particle size of 10 to 30 nm in an amount of 0.3 to 1.5 parts by mass with respect to 100 parts by mass of the styrene resin.

13. A cartridge according to claim 11, wherein at least one of the styrene resin composition out of which the first part is molded and the styrene resin composition out of which the second part is molded contains a flame retardant in an amount of 4 to 18 parts by mass with respect to 100 parts by mass of the styrene resin.

14. A cartridge according to claim 13, wherein the second part contains a phosphate flame retardant.

15. A cartridge according to claim 14, wherein the second part contains a bromine flame retardant and is free of antimony trioxide.

16. A cartridge according to claim 11, wherein the rubber-like polymers each comprise a polymer selected from the group consisting of polybutadiene, a styrene-butadiene copolymer, polyisoprene, a butadiene-isoprene copolymer, natural rubber, and an ethylene-propylene copolymer.

17. A cartridge according to claim 11, wherein the wavelength of the laser light is 750 to 3,000 nm.

18. A cartridge according to claim 11, wherein one of the first part and the second part is a cleaning frame body and the other is a drum bearing.

19. A cartridge according to claim 11, wherein one of the first part and the second part is a toner upper frame body and the other is a toner lower frame body.

20. A cartridge according to claim 11, wherein one of the first part and the second part is a toner frame body and the other is a developing frame body.

21. A process for manufacturing a cartridge, which is freely detachable from a main body of an electrophotographic image forming device, the cartridge comprising at least a first part and a second part joined with each other through a joining surface, comprising:
a step for welding and fixing the first part and the second part to each other through irradiation with laser light;
the first part is molded out of a styrene resin composition (A1) containing at least a rubber-like polymer (a1) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A1) and having a thickness of 2 mm is 5% or less; and
the second part is molded out of a styrene resin composition (B1) containing at least a rubber-like polymer (b1) having a number average particle size of 0.5 to 3.0 μm in an amount of 3 parts by mass or more to less than 6 parts by mass with respect to 100 parts by mass of a styrene resin, and a transmittance of the laser light for a resin plate molded out of the styrene resin composition (B1) and having a thickness of 2 mm is 20% or more.

22. The process for manufacturing a cartridge according to claim 21, wherein the laser welding is applied through the irradiation with laser light from the second part toward the first part.

23. The process for manufacturing a cartridge according to claim 21, wherein the wavelength of the laser light is 750 to 3,000 nm.

24. The process for manufacturing a cartridge according to claim 21, wherein one of the first part and the second part is a cleaning frame body and the other is a drum bearing.

25. The process for manufacturing a cartridge according to claim 21, wherein one of the first part and the second part is a toner upper frame body and the other is a toner lower frame body.

26. Tho process for manufacturing a cartridge according to claim 21, wherein one of the first part and the second part is a toner frame body and the other is a developing frame body.

27. A process for manufacturing a cartridge, which is freely detachable from a main body of an electrophotographic image forming device, the cartridge comprising at least a first part and a second part joined with each other through a joining surface, comprising:
a step for welding and fixing the first part and the second part to each other through irradiation with laser light;
the first part is molded out of a styrene resin composition (A2) containing at least a rubber-like polymer (a2) having a number average particle size of 0.5 to 3.0 μm in an amount of 6 to 13 parts by mass with respect to 100 parts by mass of a styrene resin, and a transmittance of the laser light for a resin plate molded out of the styrene resin composition (A2) and having a thickness of 2 mm is 5% or less; and
the second part is molded out of a styrene resin composition (B2) containing at least a rubber-like polymer (b2) having a number average particle size of 0.08 to 0.3 82 m in an amount of 6 to 13 parts by mass with respect to 100 parts by mass of a styrene resin, and a transmittance of the laser light for a resin plate molded out of the styrene resin composition (B2) and having a thickness of 2 mm is 20% or more.

28. The process for manufacturing a cartridge according to claim 27, wherein the laser welding is applied through the irradiation with laser light from the second part side toward the first part.

29. The process for manufacturing a cartridge according to claim 27, wherein the wavelength of the laser light is 750 to 3,000 nm.

30. The process for manufacturing a cartridge according to claim 27, wherein one of the first part and the second part is a cleaning frame body and the other is a drum bearing.

31. The process for manufacturing a cartridge according to claim 27, wherein one of the first part and the second part is a toner upper frame body and the other is a toner lower frame body.

32. The process for manufacturing a cartridge according to claim 27, wherein one of the first part and the second part is a toner frame body and the other is a developing frame body.
